(19) United States
(12) Patent Application Publication
(10) Pub. No.: US 2002/0002490 A1
(43) Pub. Date: Jan. 3, 2002

(54) Personalized computer peripheral

(76) Inventor: George Gerpheide, Salt Lake City, UT (US)

Correspondence Address: MORRISS, BATEMAN, O'BRYANT & COMPAGNI, P.C., 5882 SOUTH 900 EAST, SUITE 300, SALT LAKE CITY, UT, 84121, US

(21) Appl. No.: 09/823,923

(22) Filed: Mar. 29, 2001

Related U.S. Application Data
(60) Provisional application No. 60/192,931, filed on Mar. 29, 2000.

(51) Int. Cl. G06F 17/60

(52) U.S. Cl. 705/14

(57) ABSTRACT

A system for influencing a web consumer to keep a branded computer input device that has a hardwired or preprogrammable switch that directs the web consumer to a specific web site that is operated by the sponsor of the computer input device, thereby influencing the web consumer to continue to access the web site of the sponsor when the owner is seeking goods or services provided by the sponsor, and wherein the computer input device can provide any combination of web navigation, computer input ports, enabling of e-commerce, voice-over-IP telephonic communication, and audio reproduction.

### CROSS REFERENCE TO RELATED APPLICATIONS

This document incorporates by reference all of the subject matter included in a pending patent application having Ser. No. 60/135,901, filed May 26, 1999, entitled SYSTEM AND METHOD FOR ACCESSING PREDETERMINED SHOPPING WEB SITES.

### THE FIELD OF THE INVENTION

This invention relates generally to the use of a computer input device for e-commerce. More specifically, the invention relates to the personalization of the computer input device for the purposes of causing the user to use the computer input device more frequently, and also to retain the device and not replace it with another device that provides similar functions. The expected result is that the user will use the computer input device which may be branded by a particular sponsor, and/or has a non-changeable and preprogrammed direct access to goods or services provided by the sponsor on the World Wide Web.

### BACKGROUND OF THE INVENTION

The state of the prior art spans several disciplines because the present invention integrates a plurality of different technologies. Furthermore, the concept has evolved beyond its original design for a personalized touchpad. Accordingly, it is necessary to examine a host of different types of operations that can be performed by a computer or computer-type system to determine the state of the prior art. Nevertheless, fundamentally the concept of the invention is centered upon providing a desktop device that is coupled to a computer or computer-like device, where the desktop device communicates over the Internet or an equivalent Global Information Network. The relevant art thus includes a plurality of different types of desktop computer devices, the Internet, and the World Wide Web.

The World Wide Web is a feature made available on the Internet or Global Information Network. The World Wide Web is a loose collection of web sites which are comprised of viewable web pages that are viewable through the use of a web browser. The web sites generally display material that is formatted using the hypertext markup language (HTML). HTML also provides hypertext links to similarly formatted documents, as well as graphics, audio and video files. Unfortunately, the World Wide Web is crowded with many web sites, as it is estimated that at times, as many as one million new web pages are being added daily to the many millions of web pages already available. Accordingly, it is becoming increasingly difficult to attract the attention of people using the Internet for e-commerce (web consumers), and consequently it is difficult to direct a web consumer to a web site of a specific business.

In the previously mentioned provisional patent application, Ser. No. 60/135,901, a computer input device is described which provides rapid access to a specific web site by providing hard-wired and/or programmable switches in a computer input device. The switches direct the user of the computer input device to a specific web site. The web site, for example, provided a safe e-commerce shopping experience.

One of the main advantages of that computer input device is that it always directs the user to a specific web site of the sponsor. Generally, this web site is going to be owned by the provider of the computer input device. Thus, a user of the computer input device is more likely to use the switches when performing a task associated with the goods or services provided at that web site.

The issue of being a source of many different types of information to web users and web consumers has generally been addressed by the creation web portals. Web portals are web sites that try to be a one-stop location for all the needs of the web user. A typical portal provides news, weather, email, directory assistance, financial information, reference information, information regarding hobbies, health, religion, sports, and the list goes on. Portals try and provide access to a large variety of information so that the user is trained to return to the portal often.

Revenue is generally raised by portals through advertising, or by directing web consumers to particular web sites that are willing to pay the portal to feature their web site for particular goods or services. While this business may be effective for the few largest portals, it makes it practically impossible to be noticed when the portal is smaller, or perhaps provides information regarding goods or services that are tailored to a more specific purpose. Thus, the issue becomes how to direct a web consumer to a specific web site of even a specific purpose.

What is needed is a system that encourages a web consumer go to visit a specific web site whenever the web consumer wants to perform e-commerce related to the goods or services of a business that has a presence on the World Wide Web.

It is also observed that although information on the World Wide Web is technically linked together, much of the information is grouped in isolated web sites. These isolated sites cannot be reached from some of the larger and more familiar web portals. So it is not enough to simply make information available on the web if that information is not going to be accessible via a hypertext link from some other location.

Along a different line of concern, it is noted that a further complication of the matter is that a web site can hold itself out as having a certain type of information, when in fact it contains a different type. There is little that can be done to stop a web site from false advertising. The only way to know the exact contents of a particular web site are to actually visit it. Unfortunately, visiting a web site will necessarily expose the visitor to whatever subject matter that the web site actually contains.

To assist users in locating desired information, search engines were developed. Search engines, web crawlers, and other similar search systems are typically indexes which, unfortunately, do not catalog every web page on the World Wide Web. In fact, it is estimated that most search engines provide a glimpse into a mere 5% to 10% of the total number of web pages. Furthermore, the search engines often overlap each other in content, so a user is unable to know how many search engines must be employed in order to have confidence that important resources are not being missed when conducting a search.

To overcome this problem, there are programs that simultaneously perform a search using a plurality of different search engines. But even a large number of search engines do not provide access to all web pages.

The search engines themselves also raise another issue. Search engines do not screen information to verify that a web site actually contains information that it says it does. In effect, the search engine can unwittingly promote false information about the contents of a web site that is supplied by the web site to the search engine.

The problem with search engines is that they receive information regarding the contents of a web site from the web site itself, or by examining words that the web site is able to broadcast which are supposed to define web site content. What this means is that web sites can associate words with themselves which have nothing to do with their actual content. The result is that a popular search topic can deceptively be associated with an unrelated web site whose content has actually little or nothing to do with the popular search topic. So the databases or indexes that a search engine builds inevitably contain false information. Thus when a search is then performed using some keywords associated with the popular search topic, the unfortunate result is that positive search results or “hits” will be generated for these deceptive and misleading web sites.

What is also needed is a system which provides a more convenient and rapid method of web searching that will only provide search results that are in some manner guaranteed to contain the desired information. More specifically, what is needed is a way to provide a user with a pre-screened list of web sites about a selected range of pre-determined topics. In this way, the web sites that generate hits for being associate with the pre-determined topics could be thoroughly screened by others, so that erroneous and unrelated web sites can be eliminated. The system would therefore not rely on the search results provided by standard search engines.

Given the size of the Internet, such a system has practical limitations. The system would be most useful when the search topics are all known in advance for a limited range of topics so that pre-screening of web sites is not an overwhelming activity. For example, one topic could be e-commerce web sites that are being provided for the purpose of on-line or Internet shopping or browsing of goods and services.

Along with the pre-compiled list of pre-determined topics or web sites associated with a particular e-commerce subject, it is noted that navigating the web is often a laborious task. The nature of searching the web can be laborious because users are operating generalized computer input devices for navigation. For example, a keyboard in combination with arrow keys, a mouse, a touchpad or other cursor manipulation device are the most common computer input devices that are used when navigating the web. These generalized devices, while able to perform multiple functions, have the disadvantage of not being streamlined in function or operation for web navigation or browsing. These devices are also generally bulky when used in combination.

Accordingly, it would also be advantageous to have a more specialized web navigation device to enhance movement through and interaction with the web. The footprint of the device should also be more in line with typical user needs. It would also be an advantage over the prior art to customize the web navigation device so that it was specifically linked to the pre-compiled list of pre-screened web sites or to a favorite on-line merchant, to thereby facilitate an e-commerce shopping or browsing experience.

It would be another advantage over the prior art to provide more than just a computer navigation device for use with a specific sponsor that leads a web consumer to the sponsor's web site. It would be advantageous to provide desktop devices that do not provide navigation, but instead provide some other type of communication over the Internet.

### SUMMARY OF INVENTION

It is an object of the invention to provide a system and method for influencing an owner of a computer input device not to replace it.

It is another object to provide a computer input device that is personalized for the owner.

It is another object to influence the owner of the personalized computer input device to continue to visit the web site of the provider of the personalized computer input device.

It is another object to provide a touchpad as the personalized computer input device.

It is another object to personalize the computer input device by disposing an image on a surface thereof, wherein the image is associate with the brand of a sponsor of the device.

It is another object to utilize a photograph, artwork or other design that is selected by the owner of the personalized computer input device as the image disposed thereon.

It is an object of the invention to provide a system and method for improved web navigation when conducting e-commerce.

It is another object to provide a system for improved web navigation which includes a pre-screened or pre-compiled list of web sites concerning a selected range of products and services.

It is another object to provide a system for improved web navigation through pre-screened or pre-compiled lists of web sites wherein the web sites are actually visited in order to confirm their content, without relying on keywords embedded in the web sites which advertise content.

It is another object to provide a customized web navigation device that facilitates movement through and interaction with the web.

It is another object to provide a customized web navigation device that is linked by hardware, software, firmware, or a combination thereof to the pre-compiled list of web sites.

It is another object to provide a customized web navigation device that is less cumbersome to use, and is smaller than a conventional keyboard.

It is another object to provide a customized web navigation device that is conveniently coupled to the web utilizing wire or wireless technology.

It is another object to provide a customized web navigation device that has at least one dedicated web navigation switch that causes a computer display to show at least one e-commerce web site that contains the pre-compiled list.

It is another object to provide a customized web navigation device that causes a computer display to show a list of merchants that are associated with the pre-compiled list.

It is another object to provide a customized web navigation device that has at least one switch that enables a user to select a merchant from the list of merchants, and to provide access to the selected merchant's web site.

It is another object to provide a customized web navigation device that includes a variety of input devices such as a touchpad and stylus.

It is another object to provide a customized web navigation device that enables other convenient web navigation options including scrolling, moving forwards and backwards through web pages and web sites, and zooming in and out of web pages.

It is another object to provide a customized web navigation device that provides access to information regarding aspects of a particular merchant's web site, such as web site awards, web site ratings, web site popularity, and merchant trademarks.

It is another object to enable the system to provide a unique identifier code that can be associated with a particular user or user hardware, and to transmit the unique identifier code to a database.

It is another object to provide the pre-compiled list of web sites that can be updated with current and corrected information.

It is another object to provide the pre-compiled list of web sites that is stored within a memory disposed within the web navigation device.

It is another object to provide a plurality of different desktop communication devices that can all be branded by a specific sponsor of the desktop communication device.

The above objects are realized in a specific illustrative embodiment of a system for influencing a web consumer to keep a branded computer input device that has a hard-wired or programmable switch that directs the web consumer to a specific web site that is operated by the sponsor of the computer input device, thereby influencing the web consumer to continue to access the web site of the sponsor when the owner is seeking goods or services provided by the sponsor, and wherein the computer input device can provide any combination of web navigation, computer input ports, enabling of e-commerce, telephonic communication, and audio reproduction.

In accordance with a first aspect of the invention, the computer input device comprises a touchpad having a touch-sensitive surface, and wherein an image is disposed on the touchpad surface that is selected by the sponsor.

In accordance with a second aspect of the invention, the computer input device comprises a touchpad having a touch-sensitive surface, and wherein an image is disposed on the touchpad surface that is selected by the web consumer.

In accordance with a third aspect of the invention, the web consumer is less likely to discard or replace the personalized computer input device because it is personalized.

In accordance with a fourth aspect of the invention, the personalized computer input device includes at least one hard-wired or preprogrammed switch that directs the web consumer to the web site of the sponsor.

In accordance with a fifth aspect of the invention, the web consumer is influenced to use the personalized computer input device more often and even transport it to other computers, and will thereby more frequently visit the web site of the sponsor.

In a accordance with a sixth aspect of the invention, the web consumer can replace the selected image that is disposed on the personalized computer input device.

In accordance with a seventh aspect of the invention, the web consumer selects a truly personal image, not an image from a catalog provided by the sponsor, to thereby assure that the image is personal to the web consumer.

In accordance with an eighth aspect of the invention, the personalized computer input device provides the ability to access pre-screened web sites which are screened for the purpose of providing an improved e-commerce experience.

In accordance with a ninth aspect of the invention, the personalized computer input device provides improved web navigation.

In accordance with a tenth aspect of the invention, the personalized computer input device includes at least one dedicated switch which causes the browser terminal to access and display a merchant site that is selected from a merchant database.

In accordance with an eleventh aspect of the invention, the system includes pre-screening of merchant web sites in order to verify web content, so that when accessed through the system, the web consumer is guaranteed to find the expected contents.

In accordance with a twelfth aspect of the invention, the system includes categorizing the merchant web sites according to content to therefore provide structure and organization.

These and other objects, features, advantages and alternative aspects of the present invention will become apparent to those skilled in the art from a consideration of the following detailed description taken in combination with the accompanying drawings.

### BRIEF DESCRIPTION OF DRAWINGS

FIG. 1 is a block diagram which describes the state of the prior art for typical access to the web on the Internet, where a web terminal accesses and displays information retrieved via HTML from web sites.

FIG. 2 is a block diagram of the elements which are associated together in accordance with the principles of the presently preferred embodiment.

FIG. 3 is a top elevational view of the presently preferred embodiment for a Peripheral Linking Device that includes a touch sensitive touchpad surface, mechanical switches, and at least one dedicated switch that provides rapid access to a sponsor's website, to a merchant database, or a selectable website.

FIG. 4 is a screenshot of a web portal from which a web consumer can program programmable buttons on the Peripheral Linking Device.

FIG. 5 is a screenshot of the web screen that enables the web consumer to program the programmable buttons on the Peripheral Linking Device.

FIG. 6 is a perspective view of an overlay template suspended over the touch-sensitive surface of a Peripheral Linking Device.

FIG. 7 is a block diagram showing the presently preferred elements of the merchant database, including a local search engine, a relational database engine, a database of user activity, and a referral fee database.

FIG. 8 is a block diagram showing the Peripheral Linking Device which includes a non-volatile memory wherein the merchant database can be recorded for rapid recall.

### DETAILED DESCRIPTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The preferred embodiment of the present invention utilizes a touchpad as the personalized computer input device. In alternative embodiments to be discussed, other types of desktop communication appliances will be addressed.

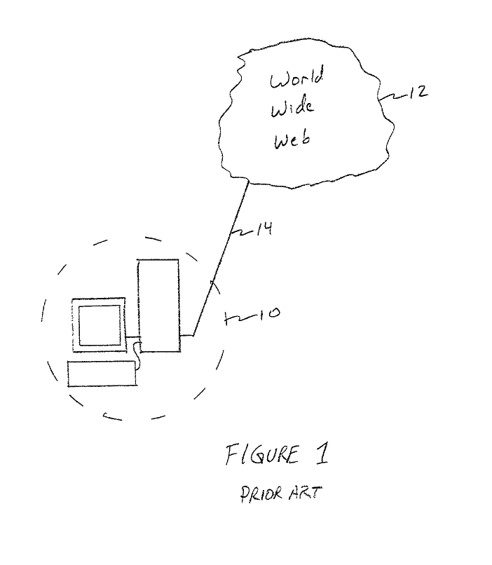

An example of the prior art is shown in FIG. 1. FIG. 1 is a block diagram which shows a web access and browser terminal 10, the world wide web 12, and a connection 14 between the web access terminal and the web. The web access and browser terminal 10 is any device or system that uses HTML to access and display the contents of documents stored in the HTML format on web sites. Accordingly, the web access and browser terminal 10 can be a desktop computer system such as the one shown that includes a CPU 16, a computer display 18 and a keyboard 20. Likewise, a laptop computer can also function as the web access and browser terminal 10. However, the web access and browser terminal 10 can also include such devices as a web enabled television.

An example of such a system is comprised of a typical analog or digital television set that includes WEBTV(TM), an Internet access system. The distinguishing characteristics of the prior art systems include access to the web, and the ability to browse the web using typical general purpose input devices.

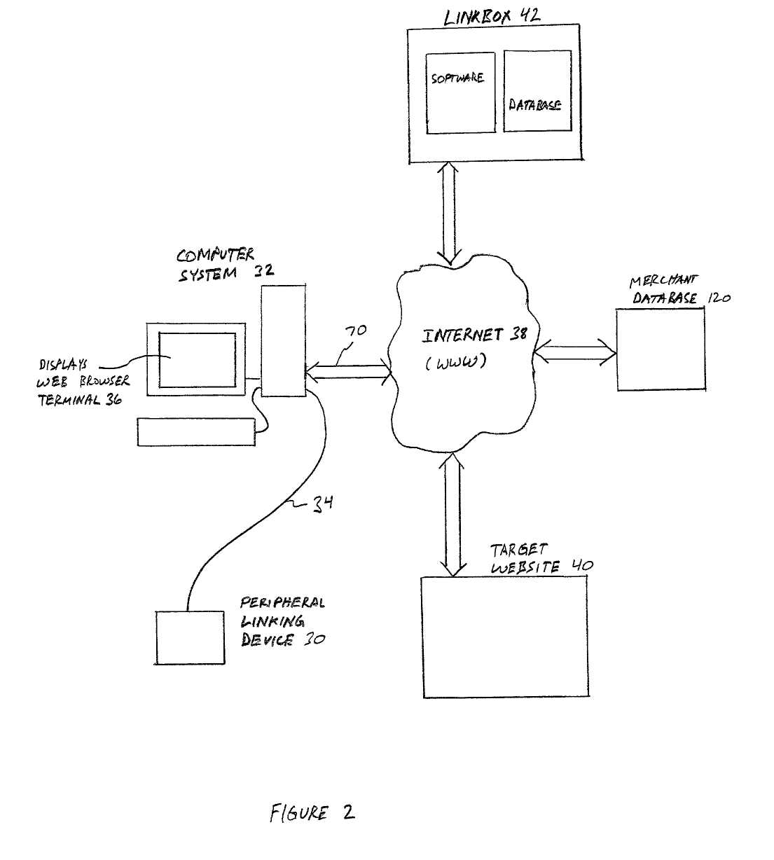

FIG. 2 is provided to illustrate the main physical components of the presently preferred embodiment of the system. The elements of the preferred embodiment include a computer input device 30 or Indelible Linker (hereinafter referred to as a Peripheral Linking Device) coupled to a computer system 32 or other device which provides access to the Internet, such as a web-enabled television.

The preferred embodiment assumes that the Peripheral Linking Device 30 functions as a web navigation device which is coupled via a wire 34 or wireless link to the computer system 32 which is at least partially functioning as a web browser terminal 36. The web browser terminal 36 is in turn coupled to the Internet 38, or more specifically, the World Wide Web (hereinafter the Web). The Web provides access to a target website 40 that is operated by a sponsor of the Peripheral Linking Device 30. The target website 40 provides at least one type of product and/or service of the sponsor. The system enables a user to easily navigate to the sponsor's web site 40 using the Peripheral Linking Device 30. This is accomplished using the Linkbox 42.

The Linkbox 42 is critical to the operation of the system, and is the guiding force that makes the present invention so advantageous over the prior art. Therefore, it will be necessary to understand how the Linkbox 42 functions in relation to the elements shown in FIG. 2.

The Peripheral Linking Device 30 shown in FIG. 2 is a top view of the presently preferred embodiment. The device 30 shown is a touchpad as sold by INDELeLINK Corporation. The Peripheral Linking Device 30 is capable of simplified web navigation by providing useful features such as horizontal and vertical scrolling 44, moving forwards 46 and backwards 48 through web pages and web sites, zooming 50 in and out of web pages, and using right 60 and left 62 buttons as found on a computer mouse. More importantly, the Peripheral Linking Device 30 includes a plurality of buttons or switches 52, 54, 56, and 58. The function of these buttons will be explained.

The Peripheral Linking Device 30 includes at least one dedicated switch or button which provides rapid access to the sponsor's web site. In other words, the browser terminal 36 is caused to display the content of the sponsor's web site 40 upon activation of a switch 52, 54, 56, 58. Along with the sponsor, it is envisioned that another one of the buttons is similarly hardwired to a web site of the manufacturer or the Peripheral Linking Device 30. It is likely that the sponsor and the manufacturer are not providing competing services, or that the services complement each other. For example, INDELeLINK Corporation is the manufacturer operating a web portal. The web consumer will likely use a hardwired button to access the sponsor's web site 40 when needing the goods or services of the sponsor, and will access the manufacturers web portal when needing other types of services, such as safe shopping.

For the added value of the web consumer, some of the buttons 52, 54, 56, 58 are programmable. This means that while at least one and probably two of the buttons 52, 54, 56, 58 are hardwired to the sponsor and to the manufacturer, the remaining buttons can be programmed to go to a web site of the choosing of the web consumer. This process will be explained later.

In the presently preferred embodiment, it should be assumed that the Peripheral Linking Device 30 that can be used as a web navigation device is responsive to a finger or a stylus and functions with any touchpad. Preferably the touchpad utilizes a capacitive-based technology, electromagnetic, electrostatic, ultrasonic, optical, resistive membrane, or other finger or stylus-responsive device. The Peripheral Linking Device 30 can also include an embossed ridge or ridges to separate the buttons 52, 54, 56, 58 from the touch sensitive touchpad surface area on the surface 64. The buttons are based on touch-sensitive switch technology used in the touchpad, or they can be mechanical switches, membrane switches, rubber-dome switches or other switch activation technology.

One of the key features of the present invention is that the Peripheral Linking Device 30 is either a branded device, a personalized device, or a combination of the two. On a touchpad as shown in FIG. 2, branding is a relatively simple procedure because of the large amount of surface area that is typically available on a surface 64 of the touchpad. For example, an overlay can be disposed on the surface 64 which includes the sponsor's name, logo or other mark that indicates the sponsor's identity.

The overlay can be permanent, but is preferably removable by the web consumer. In this way, the owner can dispose a variety of personal images to the touchpad surface 64 when the web consumer prefers to make a change. In this way, the Peripheral Linking Device 30 remains a device that the owner wants to keep using, instead of replacing or discarding. As long as the web consumer retains the device, rapid access to the sponsor's web site is always close at hand. The web consumer is therefore more likely to continue to visit the sponsor's web site. Preferential access to the sponsor's web site is only maintained as long as the web consumer uses the sponsor's Peripheral Linking Device 30.

Regarding personalization of the Peripheral Linking Device 30, the web consumer selects an image to be disposed thereon. The image can be, for example, a picture of the web consumer, family, friends, a vacation spot, scenic view, artwork or other image that is personal to the web consumer. The web consumer can provide the image to the manufacturer of the Peripheral Linking Device 30, or to the sponsor. The image can be delivered in the form of a photograph or digitized image. The image is then transferred to an overlay. The overlay is then disposed on the touchpad surface 64.

Having discussed the attributes of the Peripheral Linking Device 30 in the preferred embodiment, it is now possible to look at how the Peripheral Linking Device functions with the Linkbox 42 to enable the web consumer to access the sponsor's target web site 40.

Returning to FIG. 2, the computer system 32 is capable of accessing the Internet 38, and display the contents of web sites in a web browser running on the computer system. In order for this to take place, the computer system 32 is coupled or linked to the Internet 38 via communication link 70. The communication link 70 should be considered to be a any connection that enables access to the web. Typical communication links include a telephone modem, cable TV modem, cellular phone, fiber optic cable, RF satellite modem, Ethernet, twisted pair cabling, etc. All that is important is that web access is enabled, even if the web access is of the limited variety provided for some cellular devices.

It should be made explicitly clear that the purpose of the Linkbox 42 is to enable a web consumer to directly access the web site corresponding to the particular button 52, 54, 56, 58 that is actuated on the Peripheral Linking Device 30. But the Linkbox 42 accomplishes more than just that purpose as will be explained.

Assume that a web consumer has obtained the Peripheral Linking Device 30 from a sponsor. We will assume that the sponsor is a banking service where the web consumer keeps a checking and savings account. The type of goods or services performed by the sponsor are not material to the invention. It is only necessary that the sponsor have a web presence, and the web sponsor desires that the web consumer visit the sponsor's web site whenever there is a need for the goods or services offered by the sponsor.

The Peripheral Linking Device 30 has been preprogrammed such that button 52 is hardwired to access the sponsor's web site. This is accomplished as follows. To operate the Peripheral Linking Device 30, it is necessary that client software be installed and operating on the computer system 32. This client software enables important functions to take place. When the web consumer actuates button 52 on the Peripheral Linking Device 30, the client software on the computer system 32 receives data from the Peripheral Linking Device indicating that the web browser should display the sponsor's web site.

If the computer system 32 is not yet connected to the Internet 38, the computer system will be directed by the client software to make the connection. Likewise, the computer system 32 will be directed to actuate the web browser terminal 36.

When installing the client software, a unique identification (ID) is also generated. The unique ID is sometimes called a GUID, and is generated by looking at aspects of the computer system that are unique. All that is important is that the client software have a unique ID in order to accomplish its purposes.

Once the web browser terminal 36 is activated and the communication link 70 is established, the computer system 32 sends data to the Linkbox 42. The data includes the identity of the sponsor, the unique ID, and a link number which is the button 52, 54, 56, or 58 that was actuated by the web consumer.

The Linkbox 42 is a computer program, including a database, operating on at least one server. The database includes a list of unique IDs, the link numbers for each unique ID, and the Uniform Resource Locator (URL) addresses of all websites that a web consumer can be directed to. The Linkbox 42 determines which website the web consumer wants to see, and sends back to the computer system 32 the necessary data. This data must include the URL of the target website 40, and a tag. A tag is defined as information that will identify the web consumer as being directed to the target website 40 through the use of the Peripheral Linking Device 30.

The ability to track visitors to the target websites is critical to the business model. The manufacturer of the Peripheral Linking Devices wants to get credit for directing web consumers to the sponsor's web sites. Thus, this information must be tracked in order to be able to determine the fee to be paid to the manufacturer. This can be accomplished by providing a tag that is sent to the target website 40 when a request is sent for the data to display on the web browser terminal 36.

Another method of tracking access is to increment a counter in the Linkbox 42. A counter is kept for each sponsor, and is incremented each time a button 52, 54, 56, 58 is actuated on the Peripheral Linking Device 30. It is possible to date-stamp the counters so that the sponsor is not double-billed for access hits from the Peripheral Linking Device 30.

Once the web browser terminal 36 receives the target website URL and tag, the web browser can then access the target website 40 in the usual manner of a web browser.

Alternatively, it is possible that the computer system 32, the Peripheral Linking Device 30, or some other component could cache the data from the Linkbox 32. Caching the data would enable faster access to the target website 40, especially if the communication link 70 is not a broadband connection. Of course, it would be necessary for the Linkbox 42 to receive data so that the correct sponsor counters could be incremented. It would also be necessary to update the link information, especially if the web consumer changes the website that is access by a programmable button on the Peripheral Linking Device 30.

It is envisioned that privacy concerns may give rise to objections to the tracking of a unique ID for each Peripheral Linking Device 30. The unique ID could even be programmed into each Peripheral Linking Device 30 before it is sold. Thus, it should be possible to block transmission of the unique ID by the web consumer. However, the web consumer can be offered incentives to enable this function to occur. It is also possible to use the unique ID solely for the purposes of matching up link numbers to desired websites. In other words, the manufacturer running the Linkbox 42 does not need to record the web consumers browsing and purchasing habits, it is only a possibility. Thus, the incentives for allowing tracking of various characteristics of the web consumer might be graduated, with more incentives coming to those web consumers who allow greater tracking.

It has not yet been explained how the web consumer is able to access specific websites by actuating particular buttons 52, 54, 56, 58 on the Peripheral Linking Device 30. This function is made possible by providing an interface that enables the web consumer to program the buttons.

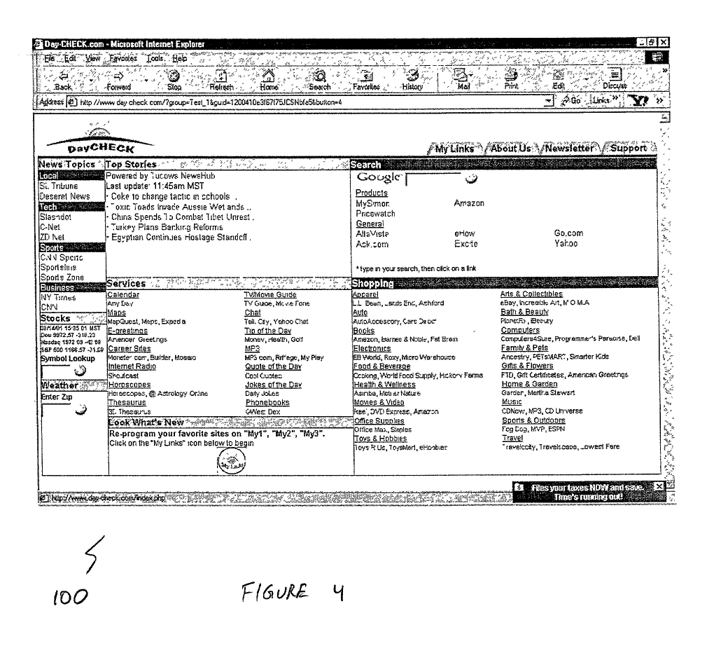

Consider FIG. 4 which is a screen shot of a web portal 100 website of the manufacturer, displayed in a web browser terminal. The portal 100 is a hardwired destination of the Peripheral Linking Device 30. The web consumer goes to the portal 100 to program the destinations of the programmable buttons by selecting the option to program the favorite sites on My1, My2 or My3 as shown in the lower lefthand corner.

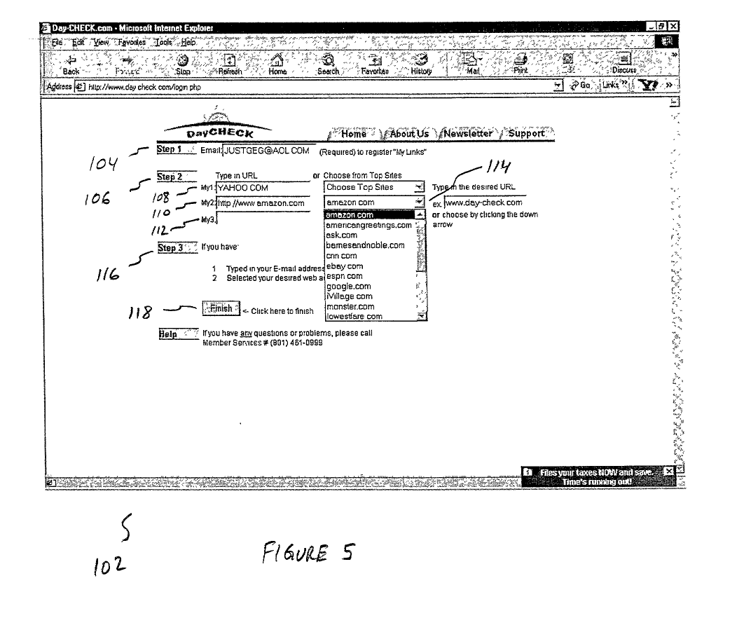

FIG. 5 is a screen shot of the web page 102 that is displayed when programming the buttons. The web consumer is requested to enter an email address in step 1 104, and then to enter the desired destination URLs in step 2 106. Each programmable button, in this case three of them 108, 110, 112, are each shown on a separate line. The web consumer either manually enters the URL, or selects a destination from a predefined list 114 that is available in a pop-down menu. The web page shows that the first programmable button 108 is assigned, for example, to YAHOO.COM(TM). The pop-down menu predefined list 114 has been actuated for the second programmable button 110, which is temporarily covering the predefined list for the third programmable button 112.

The advantage to the manufacturer of having the web consumer select from the predefined list is that a tag is more easily associated with the web consumer when visiting the target website.

Step 3 116 requests the web consumer to click on the finish button 118. This step modifies the database of the Linkbox 42 so that selecting a desired button will enable the target website to be displayed on web browser terminal 36.

There are several important alternative embodiments that should be mentioned at this point. So far, the preferred embodiment has used a touchpad as the desired Peripheral Linking Device 30. However, virtually any type of communication device can be substituted for the touchpad, depending upon the activity to be performed.

A first example is to dispose a smart card reader into the Peripheral Linking Device 30, in place of a touchpad. Smart cards are becoming important for identification and e-commerce purposes, and provide a simple way to enter smart card information into a computer system 32. The smart card reader will most likely be smaller than a touchpad as well, thereby taking up less desktop real estate.

A second example is providing voice-over-IP services by connecting a telephone to the computer system 32. This telephone would be designed to operate with the computer system 32, and not function as a device capable of communicating with a telco. It is specifically designed for use over the Internet.

A third example is providing speakers designed for playback of music that is downloaded or purchased over the Internet. In essence, the Peripheral Linking Device can be a device that can operate with an have a specific purpose on the Internet.

Having discussed the web portal 100 of the manufacturer, another aspect of the invention is to provide a safe e-commerce experience. FIG. 2 illustrates that the Internet provides access to at least one merchant database 120 stored on a web server that is coupled to the Internet 38. The merchant database 120 has been previously prepared by screening web sites of merchants who desire to have their goods and services available to users of the present invention as will be explained.

In essence, the preferred embodiment enables a user to easily navigate to the merchant database 120 stored in the web server, using the Peripheral Linking Device 30. From the merchant database 120, the user eventually selects a merchant and moves to a web site provided by the merchant. The merchant database 120 only lists merchants whose web sites have been approved for listing. The criteria for being approved for listing will be explained later. The merchant database 120 is organized such that a user can search either by merchant, or by products or services offered by the merchants.

When considering the preferred and alternate embodiments of the present invention, it should be remembered that e-commerce activities include more than just shopping on the Internet 38. With so many different companies now providing information about their products and services on the Internet 38, it is possible to do extensive research and make comparisons of competing products and services. Thus, perusing websites and learning about goods and services without actually purchasing them should be considered within the scope of the total e-commerce “shopping” experience.

Before describing the method of practicing the invention, it is useful to consider the hardware and software described in FIG. 2. For example, the web browser terminal 36 can still be any web enabled device that is capable of providing Internet access, as well as displaying the contents of web pages. This can still be accomplished, for example, via a desktop computer, a laptop computer, a video game console, WEBTV®, or a web enabled television set that includes an interactive set-top box.

The web browser terminal 36 necessarily includes the ability to browse the web and display web page information. Therefore, browser software or a comparable equivalent for viewing the contents of web pages must be running. For example, the browser software is preferably a common web browser such as NETSCAPE NAVIGATOR(TM) or MICROSOFT INTERNET EXPLORER(TM). However, it should also be considered to include web browsers that are used, for example, on small portable devices. These web browsers are more specialized to display web page information that can appear as text only, or is formatted for display on small screens.

When operating as desired, the web browser terminal 36 is running a web browser, and establishes communication between the web browser terminal 36 and the merchant database 120.

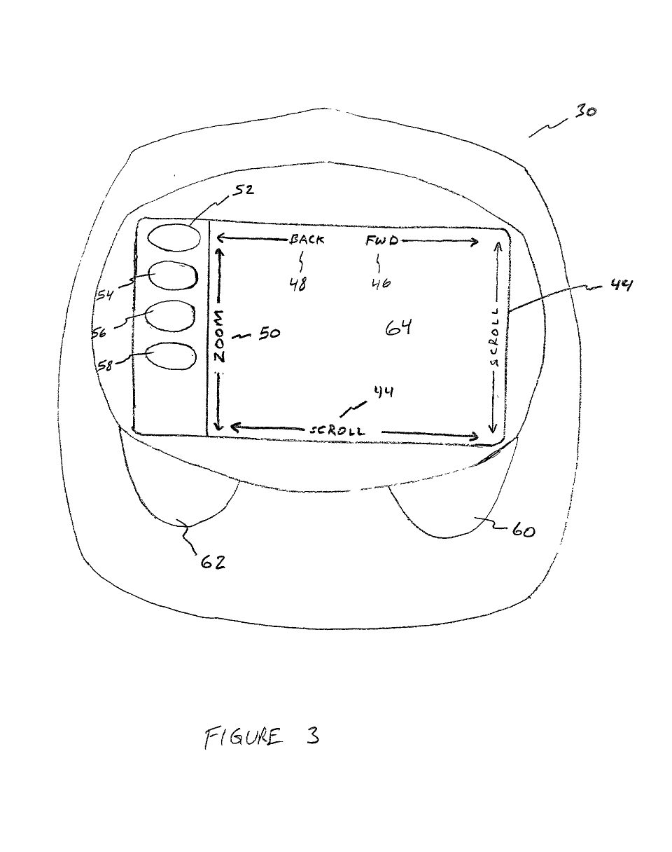

Examining the Peripheral Linking Device 30 more closely in FIG. 3, the preferred embodiment is a touchpad, such as found in the INDELeLINK Corporation's INDELePAD(TM). The touchpad is preferably a capacitance-sensitive touchpad.

The switches 52, 54, 56, 58 are preferably formed from a portion of the touch-sensitive touchpad surface 64. In other words, the touch-sensitive touchpad surface 64 can be divided into areas which are dedicated to functioning as a touch-sensitive switch, such as the buttons 52, 54, 56, 58. Other areas of the touch-sensitive touchpad surface are then dedicated to cursor manipulation.

In the presently preferred embodiment, it is envisioned that a plurality of dedicated touch-sensitive switches 52, 54, 56, 58 are provided on the touch-sensitive touchpad surface 64. The dedicated switches can be located at any convenient location on the touchpad, such as in a horizontal or vertical row along the top, bottom, or along a side.

Alternatively, dedicated switches that provide immediate access to the merchant database can come in the form of mechanical switches that are located off of the touch-sensitive touchpad surface 64. The important feature of the dedicated switch or switches is that they provide an immediate connection to the merchant database 120. There are several reasons that this is important. First, there is no fumbling through activation of a browser, and then selection of a web site from a list of bookmarks. Second, activation is fast. This type of convenience defined as access that is convenient and immediate is an important and advantageous feature of the invention.

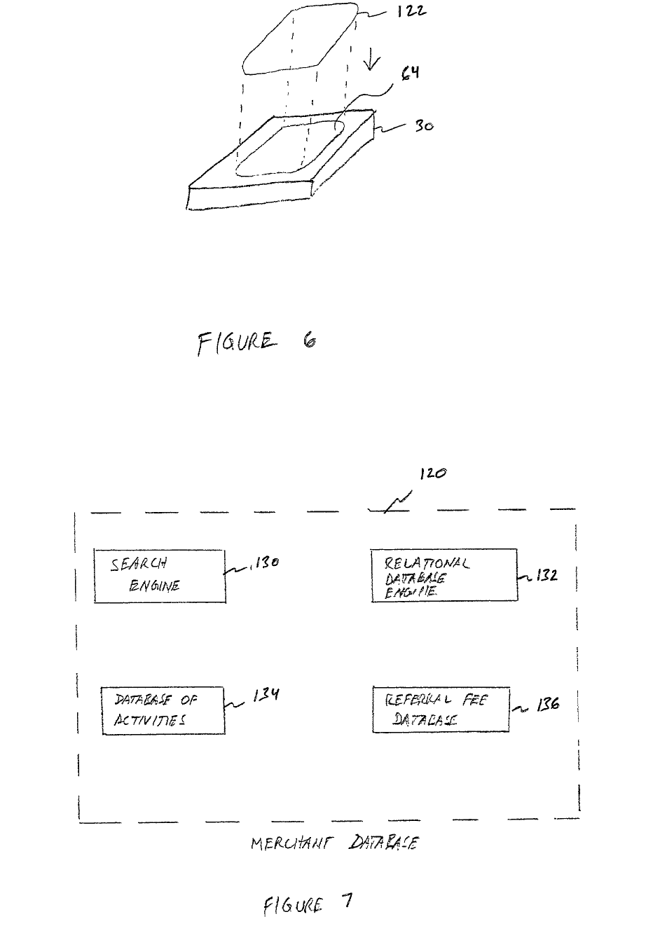

FIG. 6 illustrates that the programmable nature of the switches 52, 54, 56, 58 also impacts the use of a template or overlay 122 that can be disposed over the touchpad surface 64. The plurality of switches can be marked permanently, or can be marked temporarily using a removable or modifiable template that is disposed over the switches or the touch-sensitive touchpad surface if the switches are disposed thereon. A template 122 is generally a plastic material that an adhesive will cause to be fixed to the touch-sensitive touchpad surface 64. The adhesive can be applied to the touch-sensitive touchpad surface 64 or to the template 122 to enable the overlay to be disposed thereon.

One distinction between the Peripheral Linking Device 30 of the present invention and the prior art is that an input device such as a keyboard may have a design mark or brand name of a particular merchant. However, this brand name is typically off to the side and generally small with respect to the size of the input device. In contrast, the present invention is able to focus attention on the brand name because it is disposable on the entire touch-sensitive touchpad surface 64. The user will actually run a finger over the brand name. This ability to focus attention on a merchant or sponsor of the Peripheral Linking Device 30 appears to be unique to the present invention.

An alternative embodiment of the present invention also includes a Peripheral Linking Device that can operate in different modes. For example, a first mode enables the Peripheral Linking Device to capture a handwritten signature, a second mode can enable a miniature keyboard on the Peripheral Linking Device, and a third mode can enable a digitizing tablet interface.

An important feature of the Peripheral Linking Device of the preferred embodiment is that it is smaller than a conventional computer keyboard, thus making it convenient to operate while held in a hand or lap. Thus, the user can now sit back in a chair which is located at some distance apart from the web browser terminal 36, but still close enough for the user to see a display. Accordingly, the nature of the communication link 34 between the web browser terminal 36 and the Peripheral Linking Device 30 becomes important.

In the presently preferred embodiment, the communication link 34 is a hardwired connection. However, the nature of a wireless connection enables the user to more conveniently operate the Peripheral Linking Device 30 from a position that is generally more comfortable than a chair in front of a desk. For example, the user can sit on a couch with the Peripheral Linking Device 30 disposed on the user's lap.

A wireless link can be established between the Peripheral Linking Device 30 and the web browser terminal 36, for example, using radio frequency signals, ultrasonic signals, or infrared signals.

Although a wire limits the distance between the Peripheral Linking Device 30 and the web browser terminal 36, the limited length of the wire may not cause a problem for the user. Furthermore, the cost of implementation of a direct hardwired connection will be less than a radio frequency, ultrasonic, infrared or similar communication linking system. A hardwired connection will also be less susceptible to interference.

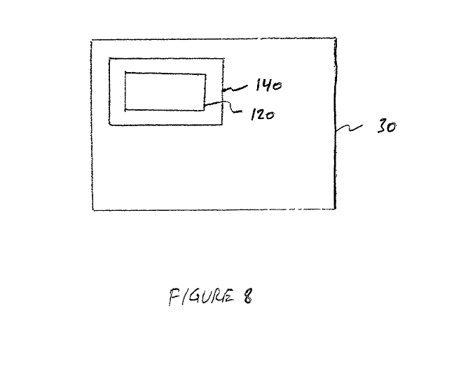

Having described the hardware of the preferred embodiment, it is important to understand the function of the merchant database 120 stored on the web server, and how it can interact with the Peripheral Linking Device 30. A block diagram of the merchant database 120 is shown in FIG. 7 to illustrate that it is used to describe a database on the web server that a user of the system is directed to access in order to have a safer online shopping experience. This does not mean that the user will necessarily make a purchase from a merchant included in the database. The safe online shopping experience refers to the aspect of the invention that the merchant web sites that are included in the merchant database 120 are pre-screened.

Stating that a merchant web site is pre-screened can mean various things. In other words, there might be various levels of screening. For example, at a minimum, a merchant web site has been visited to verify that the nature of the web site is as advertised. However, it should be apparent that there is no guarantee of the quality or usability of the goods or services of the merchant, other than warranties made by the merchant itself. Furthermore, the merchant websites may change ownership or purpose. Thus, periodic re-inspection of merchant websites is a policy of the presently preferred embodiment.

Despite the inevitable changes that take place on the web, there are some minimum standards that a merchant website must meet in order to be included in and remain on the merchant database 120. For example, the merchant website cannot contain any content or subject matter that is offensive. Obviously, the term “offensive” can have broad meaning. In this context, the term generally includes material that is typically referred to as pornographic, hateful, or demeaning of others. However, the standards reflected by this definition can be modified for the particular situation.

The merchant database 120 is organized by listing associated goods and services in a single location. For example, if a user wants to purchase a vehicle, pre-screened on-line car, truck and van dealers will all be listed together. One advantage of this system is that the user does not have to employ a search engine that will show search results that include non-screened merchant web sites. Pre-screened merchant web sites that deal in the desired goods and services are all found in a single merchant database 120 of the present invention. The user can then locate desired goods and services using several different methods.

One method for the user to search for merchants of particular goods and services is to use a search engine 130 (FIG. 7) provided as part of the merchant database on the merchant website. In the presently preferred embodiment, the search engine 130 is dedicated to providing search results that are confined to the contents of the merchant database 120.

Another search method is where the user can choose to visually search through an alphabetical list of either the goods and services, or the names of the merchants. To do this type of searching, the merchant database 120 has incorporated therein a relational database engine 132 for sorting through the merchant database 120 and organizing data into desired relationships. Advantageously, the user is able to accomplish the search without leaving the confines of the merchant database 120. Non-screened merchant websites will not appear in any of the listings or search results.

Another aspect of the merchant database 120 is that the number of merchants in any particular shopping category can be limited in accordance with user selectable criteria in order to avoid overwhelming the user. For example, the total number of merchants displayed for a particular category of goods and services can be limited to the number of merchants that can be conveniently listed on a single browser page, or even adapted to mini-browsers.

Another useful feature of the presently preferred embodiment is that information about a particular merchant is accessible to the user. This feature can be particularly important when shopping online because of the relatively anonymous identity of the merchant. A well designed merchant web site can attract consumers. But it is only after a purchase is made that numerous problems dealing with the merchant may arise. In addition, there will always be new users on the Internet who will feel some trepidation about what is often misperceived as a dangerous method of shopping. By making the user more familiar with an online merchant with whom the user is dealing, consumer fears can be minimized. Information about merchants can include but is not limited to such topics as popularity of a web site, awards received by a web site, performance ratings given by independent rating agencies, better business bureau statistics and reports, and trademark information.

Another feature of the present invention is the ability to collect information regarding each specific user. Relevant information includes, for example, the purchasing habits of specific users. This information does not have to be sold to third parties to be useful. For example, purchasing habits can then be used to determine which ads or banners will appear when a particular user is accessing the merchant database 120. This information can also be used to modify the features of the merchant database 120, including adding more merchants of particular goods and services that are of particularly high interest to users who have previously made on-line purchases. A first example is that more florists might be made available to users around particular holidays. A second example is that merchants of sporting goods are made available to a previous purchaser of hunting, fishing or outdoor equipment. This information is preferably recorded in the merchant database 120 and stored in a database of user activity 134.

There are various ways that a specific user can be identified to the merchant database 120. For example, a web browser terminal 36 can have associated with it an Internet cookie which identifies the user, as is understand by those skilled in the art. Alternatively, each Peripheral Linking Device 30 can have a unique identification stored in hardware. This identification can be accessed by the merchant database 120. This is useful when, for example, a user moves the Peripheral Linking Device 30 from one computer to another. In this example, a cookie would not identify the user as being the same user because access is being made from a different computer. This unique identification in the Peripheral Linking Device 30 serves as a prime motivation to encourage the user to keep the Peripheral Linking Device 30 even if a computer to which it has been attached is being replaced or upgraded.

In an alternative embodiment, another useful feature is the ability to provide information to the merchant regarding the identity of a consumer. This information could be the same type of information that is provided by an Internet cookie, or could be more detailed information. This detailed information can be made available to the merchant by identifying the user by using the unique identifier that can be made part of the hardware of the Peripheral Linking Device 30. However, the option can also be provided to the user to have all such information blocked from the merchant when there are privacy concerns.

It has been explained that access to the merchant database 120 that is stored on the web server is important to the presently preferred embodiment. However, in an alternative embodiment, it can be useful to store the merchant database 120 elsewhere. One reason this procedure can be useful is redundancy. The user can be assured of access to the merchant database 120 regardless of the status of the web server.

Another reason that it can be useful to redundantly store the merchant database 120 is speed. Until broad bandwidth access to the Internet is more ubiquitous, access speed is a severe restriction on usability. Accordingly, it might be useful to store the merchant database on a storage device that is local to the user. For example, the merchant database can be stored on the hard drive of a computer which is functioning as the web browser terminal 36.

However, if the merchant database 120 is being stored locally, an integral feature of the present invention cannot be ignored. Namely, the merchant database 120 must be up-to-date or synchronized in all of its locations where it can be stored. This requirement is most likely a necessity because of the nature of the Internet. The Internet is touted as fast-paced and up-to-date e-commerce. Accordingly, another feature of the present invention is the ability to automatically or manually update a locally stored merchant database 120.

FIG. 8 illustrates that local storage of the merchant database 120 can even be accomplished within the Peripheral Linking Device 30. For example, the Peripheral Linking Device 30 can include non-volatile random access memory (RAM) 140. The merchant database 120 is thus stored in the RAM 140 of the Peripheral Linking Device 30. This feature can be extremely advantageous when the user wants to move the Peripheral Linking Device 30 to another web browser terminal 36. This way, the merchant database 120 is mobile with the Peripheral Linking Device 30.

Another advantageous feature of the present invention is the layout of information from the merchant database 120. In other words, the user will always see the merchant database 120 in the same format on a web browser, regardless of whether the user is accessing the web server, or a local storage device. This feature is important when dealing with those users who can be bewildered by the array of different styles of web sites that permeate the web. By offering a consistent interface to the merchant database 120, the user is assured of consistency regardless of how access is obtained.

Local storage of the merchant database 120 enables another advantageous feature. The user is also able to search the merchant database 120 offline. This feature is useful for several reasons. For example, the user may be in a location where access to the Internet is not possible, such as on an airplane. The user might also be in a location where access is limited or slow. Furthermore, the user may simply want to conduct searches of the merchant database 120 without needing to go to a merchant's web site.

In an alternative embodiment, it is observed that the Peripheral Linking Device 30 has always been described as a unit that is separate from the web browser terminal 36. This does not have to be the case. For example, the Peripheral Linking Device 30 can be integral to the web browser terminal 36. For example, consider a laptop computer that has an integral touchpad for data input. Likewise, the Peripheral Linking Device 30 can be a touchpad that is integral to a keyboard of the web browser terminal 36. All of these configurations are possible because the components of the Peripheral Linking Device 30 can all be contained within, for example, a touchpad such as the INDELEePAD(TM) by INDELeLINK Corporation.

Referring to the technology of the Peripheral Linking Device 30 itself, it is observed that the touchpad preferably utilizes a capacitive-based technology. However, a touchpad can also be implemented using electromagnetic, electrostatic, ultrasonic, optical, resistive membrane, or other finger or stylus responsive surface. This is because the Peripheral Linking Device 30 is responsive to either a finger or a stylus used as the pointing object.

It should be assumed that the present invention will function properly on other networks and using other protocols than just those provided by the web or the Internet. In other words, while HTML and TCP/IP are ubiquitous protocols, they may eventually be replaced by protocols that offer advantages including increased functionality. Furthermore, the principles of the present invention can be applied to any network, global or not.

Another alternative embodiment of the present invention is the ability to capture a signature. Because the present invention pertains to e-commerce, it can be important to have the ability to record an actual signature. This is not a digital signature. An actual signature might be needed in order to make a purchase from some merchants who want to provide increased security for web-based transactions. The actual signature can be digitized and recorded by the merchant, and a paper copy can be provided to the user. Just as important is the feature that by using pressure sensitive paper, the user can more easily write a signature on a touchpad surface because the user can actually see it. This is in contrast to the situation of having to sign a touchpad or a digital tablet when there is no way to “see” where the user is writing.

The present invention should also be recognized for another advantageous feature that it provides. Specifically, merchants are receiving web traffic (web hits) and even purchases made by users of the system. Users of the system have been led to the merchant via the merchant database. Accordingly, these merchants can also pay referral fees to the operator of the merchant database. Referrals fees can be based on several different criteria. A first fee can be paid to the merchant database operator for simply enabling a user to link to the merchant's web site from the merchant database, regardless of whether or not a purchase was made. A second and typically higher referral fee can be paid when the user actually makes a purchase from the merchant. A referral fee database 136 (FIG. 7) is therefore preferably maintained within the merchant database 120. The referral fee database 136 simply records the number of Peripheral Linking Devices 30 that link to a merchant's web site from the merchant database 120.

The value of directing users to a particular merchant should not be overlooked. A merchant's success in e-commerce depends upon users being able to locate the merchant's web site. The more users that can be directed to the web site, the more opportunities there are for sales. Accordingly, web merchants are more than willing to pay referral fees because of the likely outcome of more web hits.

It has been explained above that the plurality of dedicated switches 52, 54, 56, 58 can be programmed to correspond to a variety of different shopping categories of goods and services. In another alternate embodiment, the plurality of dedicated switches can be programmed to take a user to a specific merchant or sponsor web site. For example, if the user likes to make on-line purchases of books, two switches can be programmed to take the user directly to two different on-line merchants of books. In another example, the first switch may take the user to a home page of a merchant or sponsor, and a second switch may take the user to a specific page within the merchant web site.

However, just because a user is able to go to a merchant's home page, it does not necessarily mean that the user went directly to that site. Thus, in an alternative embodiment, the user is passed through the merchant database 120, and then directed to the merchant's web site. This “redirection” has advantages. For example, assume that the home page of the merchant changes. The user may not be aware of this change, and thus a switch takes the user to a non-existent site, resulting in an error message.

Thus, by redirecting a user to a merchant's web site by passing through the merchant database 120, any changes in the myriad of merchant's web sites are all handled by the merchant database. This has the advantage of making the process seamless to the user, and provides the benefit to the merchant of keeping users who have become accustomed to purchasing or browsing their goods and services. The only cost to the merchant is the referral fee that is generated by passing the user through the merchant database 120.

Another advantage of this embodiment is that redirection is automatic and transparent to the user. Any process that does not require a user to change a procedure benefits the merchant. Furthermore, it avoids having to update the programmed URL's that are associated with the plurality of switches.

Another advantage of the redirection embodiment arises when a merchant fails to pay referral fees. If the operator of the merchant database 120 is not being paid for the referrals, the merchant database operator is able to redirect the users to the web site of a merchant who is willing to pay the referral fee.

Finally, it is noted that the merchant database 120 can easily track all accesses of a user to any merchant if all accesses pass through the merchant database. The user is not bothered because the redirection process is seamless and does not interfere with rapid access to the merchant's web site.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for facilitating retention of a computer input device that is used for navigation among web pages that are accessible via a Global Information Network, said method comprising the steps of:
(1) providing the computer input device for facilitating navigation to web sites and among web pages, wherein the computer input device includes at least one touch-sensitive surface whereby data is input to the computer input device;
(2) providing a web browser terminal which is controllable by the computer input device, wherein the web browser terminal includes a visual display and a web browser for accessing the web sites and displaying the web pages;
(3) selecting an image to be disposed on the at least one touch-sensitive surface; and
(4) disposing the image selected by the owner on the at least one touch-sensitive surface of the computer input device, to thereby personalize the computer input device, and thereby influence the owner to keep and use the computer input device.

2. A system for providing access to a preprogrammed website on the Internet from a peripheral linking device that is programmed to direct access to the website, said system comprising:
a peripheral linking device;
at least one programmable button on the peripheral linking device;
a computer system that receives input from the peripheral linking device, and which has access to the Internet; and
a linkbox database disposed on the Internet, wherein the linkbox database includes a database for the peripheral linking device that associates an address of the website with the at least one programmable button, wherein actuating the at least one programmable button on the peripheral input device causes the linkbox database to send to the computer system an address of the website.

3. A system for facilitating navigation among websites and web pages at the websites that are accessible via the world wide web, said system comprising a peripheral input device for facilitating navigation in the world wide web, wherein the peripheral input device includes:
at least one touch-sensitive surface whereby data is input to the peripheral input device, and wherein the at least one touch-sensitive surface includes an image disposed thereon; and
at least one switch which actuates an activity associated with web navigation.

4. A system for facilitating navigation among websites and web pages at the websites that are accessible via the web, said system comprising:
a peripheral input device for facilitating navigation in the world wide;
a browser terminal which is coupled to the peripheral input device, and which displays information retrieved from the world wide web by using the peripheral input device; and
a merchant database which is hosted at a merchant database website and which displays merchant information, wherein the peripheral input device navigates to the merchant database to thereby display the merchant information on the browser terminal.

5. A system for facilitating navigation among websites and web pages at the websites that are accessible via the web, said system comprising:
a peripheral input device for facilitating navigation in the world wide web, wherein the peripheral input device includes:
at least one touch-sensitive surface whereby data is input to the peripheral input device; and
at least one switch which performs an activity associated with web navigation;
a browser terminal which is coupled to the peripheral input device, wherein the browser terminal includes:
a visual display; and
a web browser for accessing the websites and displaying the web pages; and
a merchant database which is hosted at a merchant database website and which displays merchant information, wherein the peripheral input device navigates to the merchant database to thereby display the merchant information on the browser terminal.

6. A method for facilitating navigation among websites and web pages that are accessible via the world wide web, wherein the system facilitates e-commerce, said method comprising the steps of:
(1) providing a peripheral input device for facilitating navigation in the world wide web, wherein the peripheral input device includes at least one touch-sensitive surface whereby data is input to the peripheral input device, and wherein the at least one touch-sensitive surface includes an image disposed thereon, and at least one switch which performs an activity associated with web navigation;
(2) providing a browser terminal which is coupled to the peripheral input device, and which displays information retrieved from the world wide web by using the peripheral input device; and
(3) navigating the world wide web by providing input to the peripheral input device to thereby control the browser terminal so as to display desired web pages.

7. The method as defined in claim 6 wherein the method further comprises the steps of:
(1) selecting an image to dispose on the touch-sensitive surface;
(2) applying an adhesive to the touch-sensitive surface; and
(3) disposing the image to the touch-sensitive surface such that the image is held in place by the adhesive.

8. The method as defined in claim 7 wherein the method further comprises the steps of:
(1) removing the image from the touch-sensitive surface;
(2) selecting a new image; and
(3) disposing the new image on the touch-sensitive surface, to thereby customize the peripheral input device as desired.

9. The method as defined in claim 7 wherein the method further comprises the step of customizing the peripheral input device by prominently disposing a design that is associated with a particular merchant on the touch-sensitive surface to thereby indicate sponsorship of the peripheral input device.
